(19) United States
(12) Patent Application Publication
(10) Pub. No.: US 2023/0109206 A1
(43) Pub. Date: Apr. 6, 2023

(54) OWN POSITION ESTIMATION APPARATUS AND OWN POSITION ESTIMATION METHOD

(71) Applicant: Mitsubishi Electric Corporation, Tokyo (JP)

(72) Inventors: Takefumi HASEGAWA, Tokyo (JP); Tadahiko URANO, Tokyo (JP); Takuji MORIMOTO, Tokyo (JP); Kentaro ISHIKAWA, Tokyo (JP); Kyosuke KONISHI, Tokyo (JP); Taku UMEDA, Tokyo (JP)

(73) Assignee: Mitsubishi Electric Corporation, Tokyo (JP)

(21) Appl. No.: 17/888,660

(22) Filed: Aug. 16, 2022

(30) Foreign Application Priority Data
Oct. 1, 2021 (JP) 2021-162488

(51) Int. Cl. G01C 21/28; G06T 7/73; G06V 20/56; G06V 20/58; G01S 13/931

(52) U.S. Cl. CPC G01C 21/28; G06T 7/73; G06V 20/588; G06V 20/58; G01S 13/931; G06T 2207/30256; G06T 2207/30261

(57) ABSTRACT

To provide an own position estimation apparatus and an own position estimation method which can correct the position coordinate of own vehicle, even if a periphery monitoring apparatus in which detection points detected with good accuracy at the same timing is few is used. An own position estimation apparatus detects relative positions of a road side wall based on detection information of a periphery monitoring apparatus; converts the past relative positions, into relative positions on a basis of the current position of the own vehicle, and superimposes the current relative positions and the past relative positions after conversion; searches for a relative position relation that a coincidence degree between the relative positions of the road side wall after superposition and the positions of the road side wall of the map data becomes high; and corrects the position coordinate of the own vehicle based on the relative position relation.

### INCORPORATION BY REFERENCE

The disclosure of Japanese Patent Application No. 2021-162488 filed on Oct. 1, 2021 including its specification, claims and drawings, is incorporated herein by reference in its entirety.

### BACKGROUND

The present disclosure is related with an own position estimation apparatus and an own position estimation method.

Previously, the technology which compares the ground object information detected by the periphery monitoring apparatus, such as the camera, with the map data around the vehicle, and corrects the position coordinate of the own vehicle detected by the GPS signal and the like is disclosed.

### SUMMARY

For example, in the own vehicle position recognition device of JP 2018-59744 A, the ground object information detected by the periphery monitoring apparatus is compared with the map data around the vehicle, and the position coordinate of the own vehicle is corrected. When the detection points of the ground object by the periphery monitoring apparatus are few, the correction accuracy of the position coordinate by the ground object decreases. In order to suppress this accuracy decrease, in the technology of the JP 2018-59744 A, the weight of the correction amount is decreased when the detection points of the ground object are few; the weight of the correction amount is increased when the detection points of the ground object are many; and the position coordinate of the own vehicle is corrected by the ground object information.

In the automatic driving system of JP 6380422 B, the first means which determines the own position information based on the GPS signal and the map data is compared with the second means which determines the own position information based on the relative position information between the own vehicle and the ground object on the basis of ground object information detected by the periphery monitoring apparatus (camera, millimeter wave radar), and the map data. And when the difference between the own position information of the first means and the own position information of the second means is greater than or equal to the threshold value, the automatic driving control is performed using the own position information of the first means. When the difference is greater than or equal to the threshold value, it is assumed that wrong detection occurred in the periphery monitoring apparatus side. And, by not using the own position information of the second means, the accuracy decrease of the own position information by the wrong detection of periphery monitoring apparatus is suppressed.

However, in these conventional technologies, if a periphery monitoring apparatus, such as a millimeter wave radar in which detection points detected with good accuracy at the same timing are few, is used, the ground object cannot be detected with good resolution. Accordingly, since the feature of the ground object is not obtained, the correspondence relation between the ground object and map data cannot be obtained, and the own position cannot be corrected.

The technologies of JP 2018-59744 A and JP 6380422 B assumes that the detection resolution of the ground object by the periphery monitoring apparatus is high, these are inapplicable to a periphery monitoring apparatus, such as a millimeter wave radar, whose detection resolution of the ground object is originally low.

Then, the purpose of the present disclosure is to provide an own position estimation apparatus and an own position estimation method which can correct the position coordinate of an own vehicle with good accuracy, using object information detected by a periphery monitoring apparatus, even if a periphery monitoring apparatus in which detection points detected with good accuracy at the same timing is few is used.

An own position estimation apparatus according to the present disclosure including:

a side wall detection unit that detects relative positions of a road side wall on a basis of a position of an own vehicle, based on detection information of a periphery monitoring apparatus which monitors periphery of the own vehicle;

an own vehicle state detection unit that detects a position coordinate and traveling information of the own vehicle;

a detected side wall superposition unit that converts the relative positions of the road side wall detected in the past, into relative positions of the road side wall on a basis of the current position of the own vehicle, based on the traveling information, and superimposes the current relative positions of the road side wall and the past relative positions of the road side wall after conversion at a plurality of time points and calculates relative positions of the road side wall after superposition;

a map side wall acquisition unit that acquires positions of the road side wall corresponding to the position coordinate, from map data;

a side wall coincidence search unit that searches for a relative position relation of the road side wall that a coincidence degree between the relative positions of the road side wall after superposition and the positions of the road side wall of the map data becomes high; and

a position correction unit that corrects the position coordinate of the own vehicle, based on the relative position relation of the road side wall, and calculates a position coordinate after correction.

An own position estimation method according to the present disclosure including:

a side wall detection step of detecting relative positions of a road side wall on a basis of a position of an own vehicle, based on detection information of a periphery monitoring apparatus which monitors periphery of the own vehicle;

an own vehicle state detection step of detecting a position coordinate and traveling information of the own vehicle;

a detected side wall superposition step of converting the relative positions of the road side wall detected in the past, into relative positions of the road side wall on a basis of the current position of the own vehicle, based on the traveling information, and superimposing the current relative positions of the road side wall and the past relative positions of the road side wall after conversion at a plurality of time points and calculating relative positions of the road side wall after superposition;

a map side wall acquisition step of acquiring positions of the road side wall corresponding to the position coordinate, from map data;

a side wall coincidence search step of searching for a relative position relation of the road side wall that a coincidence degree between the relative positions of the road side wall after superposition and the positions of the road side wall of the map data becomes high; and

a position correction step of correcting the position coordinate of the own vehicle based on the relative position relation of the road side wall, and calculating a position coordinate after correction.

According to the own position estimation apparatus and the own position estimation method of the present disclosure, since the relative positions of the road side wall after superposition are calculated by superimposing the relative positions of the road side wall detected in the past by the periphery monitoring apparatus, even if a periphery monitoring apparatus in which detection points detected with good accuracy at the same timing are few is used, the detection resolution of the relative positions of the road side wall can be improved. At this time, since superposition is performing after converting the relative positions of the road side wall detected in the past, into relative positions of the road side wall on the basis of the current position of the own vehicle, based on the traveling information of the own vehicle, it can suppress the deterioration of the accuracy of superposition, due to the moving of the own vehicle. Then, the position coordinate of the own vehicle is corrected, based on the relative position relation of the road side wall that the coincidence degree between the relative positions of the road side wall after superposition and the positions of the road side wall of the map data becomes high, and the accuracy of the position coordinate of the own vehicle can be improved.

### BRIEF DESCRIPTION OF THE DRAWINGS

FIG. 1 is a schematic block diagram of the own position estimation apparatus according to Embodiment 1;

FIG. 2 is a schematic hardware configuration figure of the own position estimation apparatus according to Embodiment 1;

FIG. 3 is a schematic hardware configuration figure of the another example of the own position estimation apparatus according to Embodiment 1;

FIG. 4 is a flowchart for explaining schematic processing of the own position estimation apparatus according to Embodiment 1;

FIG. 5 is a figure explaining the relative position on the basis of the position of the own vehicle (position of an own vehicle coordinate system) according to Embodiment 1;

FIG. 6 is a figure explaining the current relative positions of the road side wall detected by the millimeter wave radar according to Embodiment 1;

FIG. 7 is a figure explaining the relative positions of the road side wall after superposition according to Embodiment 1;

FIG. 8 is a figure explaining the current moving amount of the own vehicle on the basis of the past position of the own vehicle according to Embodiment 1;

FIG. 9 is a figure explaining conversion of the past relative positions of the road side wall according to Embodiment 1;

FIG. 10 is an image figure of the high precision three-dimensional map data according to Embodiment 1;

FIG. 11 is a figure explaining the positions of the road side wall of the map data according to Embodiment 1;

FIG. 12 is a figure explaining processing of the side wall coincidence search unit and the position correction unit according to Embodiment 1;

FIG. 13 is a schematic block diagram of the own position estimation apparatus according to Embodiment 2;

FIG. 14 is a flowchart for explaining schematic processing of the own position estimation apparatus according to Embodiment 2;

FIG. 15 is a figure explaining the dead angle range due to the detection obstacle according to Embodiment 2;

FIG. 16 is a figure explaining missing of the relative positions of the road side wall due to the detection obstacle according to Embodiment 2;

FIG. 17 is a figure explaining interpolation of the missing part of the relative positions of the road side wall according to Embodiment 2;

FIG. 18 is a figure explaining interpolation of the missing part of the relative positions of the road side wall according to Embodiment 2;

FIG. 19 is a schematic block diagram of the own position estimation apparatus according to Embodiment 3;

FIG. 20 is a flowchart for explaining schematic processing of the own position estimation apparatus according to Embodiment 3; and

FIG. 21 is a figure explaining the area (specific area) where the detection accuracy by the millimeter wave radar is high according to Embodiment 4.

### DETAILED DESCRIPTION OF THE EMBODIMENTS

### 1. Embodiment 1

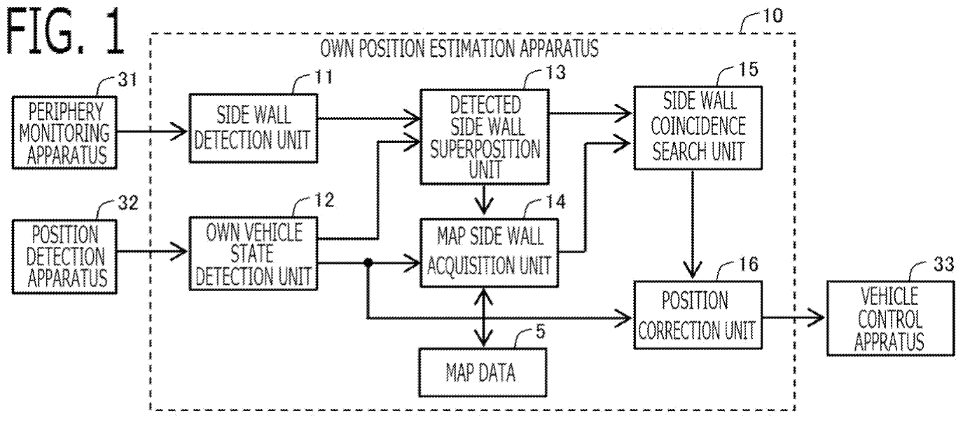

An own position estimation apparatus and an own position estimation method according to Embodiment 1 will be explained with reference to drawings. FIG. 1 is a schematic block diagram of the own position estimation apparatus 10. In the present embodiment, the own position estimation apparatus 10 may be embedded in the vehicle control apparatus which controls an own vehicle, such as automatic driving.

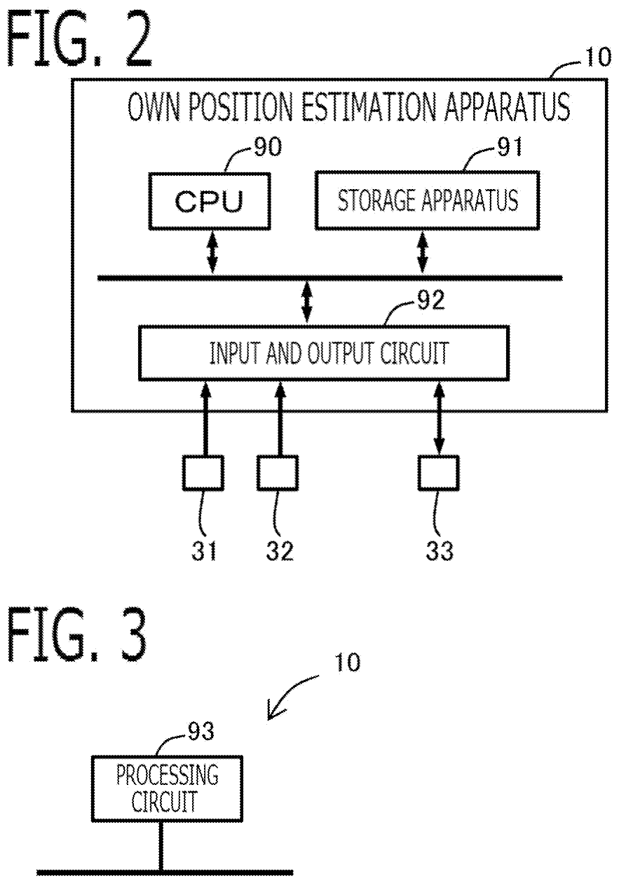

The own position estimation apparatus 10 is provided with processing units such as, a side wall detection unit 11, an own vehicle state detection unit 12, a detected side wall superposition unit 13, a map side wall acquisition unit 14, a side wall coincidence search unit 15, and a position correction unit 16. Each processing of the own position estimation apparatus 10 is realized by processing circuits provided in the own position estimation apparatus 10. As shown in FIG. 2, specifically, the own position estimation apparatus 10 is provided with an arithmetic processor 90 such as CPU (Central Processing Unit), storage apparatuses 91, an input and output circuit 92 which outputs and inputs external signals to the arithmetic 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, there are provided a RAM (Random Access Memory) which can read data and write data from the arithmetic processor 90, a ROM (Read Only Memory) which can read data from the arithmetic processor 90, and the like. As the storage apparatuses 91, various kinds of storage apparatus, such as a flash memory, EEPROM (Electrically Erasable Programmable Read Only Memory), a hard disk, and a DVD apparatus may be used.

The input and output circuit 92 is provided with a communication device, an A/D converter, an input/output port, a driving circuit, and the like. The input and output circuit 92 is connected to the periphery monitoring apparatus 31, the position detection apparatus 32, the vehicle control apparatus 33, and the like, and communicates with these apparatuses.

Then, the arithmetic processor 90 runs software items (programs) stored in the storage apparatus 91 such as a ROM and collaborates with other hardware devices in the own position estimation apparatus 10, such as the storage apparatus 91, and the input and output circuit 92, so that the respective functions of the processing units 11 to 16 included in the own position estimation apparatus 10 are realized. Setting data items such as a determination value to be utilized in the processing units 11 to 16 are stored, as part of software items (programs), in the storage apparatus 91 such as a ROM. Each function of the own position estimation apparatus 10 will be described in detail below.

Alternatively, as shown in FIG. 3, the own position estimation apparatus 10 may be provided with a dedicated hardware 93 as the processing circuit, for example, a single circuit, a combined circuit, a programmed processor, a parallel programmed processor, ASIC, FPGA, GPU, AI chip, or a circuit which combined these.

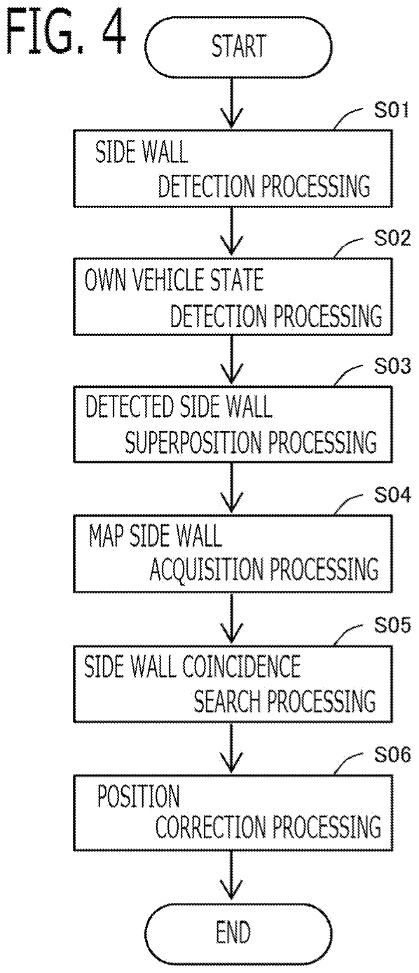

FIG. 4 is a schematic flowchart for explaining the procedure (the own position estimation method) of processing of the own position estimation apparatus 10 according to the present embodiment. The processing of the flowchart in FIG. 4 is recurrently executed every predetermined calculation period by the arithmetic processor 90 executing software (a program) stored in the storage apparatus 91.

### 1-1. Side Wall Detection Unit 11

In the step S01 of FIG. 4, the side wall detection unit 11 executes a side wall detection processing (a side wall detection step) that detects relative positions of a road side wall on a basis of a position of an own vehicle, based on detection information of a periphery monitoring apparatus 31 which monitors periphery of the own vehicle.

The periphery monitoring apparatus 31 is an apparatus which monitors periphery of the own vehicle. The periphery monitoring apparatus 31 monitors at least front of the own vehicle. As the periphery monitoring apparatus 31, a millimeter wave radar is provided at least. A camera is also provided as the periphery monitoring apparatus 31. As the periphery monitoring apparatus 31, a laser radar (LiDAR (Light Detection and Ranging)), an ultrasonic radar, and the like may be provided.

The millimeter wave radar irradiates a millimeter wave to a predetermined angle range in front of the own vehicle, and receives a reflected wave reflected by an object. Then, the millimeter wave radar detects an incident angle of the reflected wave (an angle at which the object which reflected the millimeter wave exists), and a distance to the object which reflected the millimeter wave, based on the received reflected wave. Various kinds of methods are used for the millimeter wave radar.

The side wall detection unit 11 detects a relative position of a detection object in front of the own vehicle on the basis of the position of the own vehicle, based on the detection signal of the millimeter wave radar. The side wall detection unit 11 detects the relative position of each detection object on the basis of the position of the own vehicle, based on a preliminarily set irradiation angle range of millimeter wave on the basis of the position of the own vehicle, and the irradiation angle and the distance of each detection object which were detected by the millimeter wave radar.

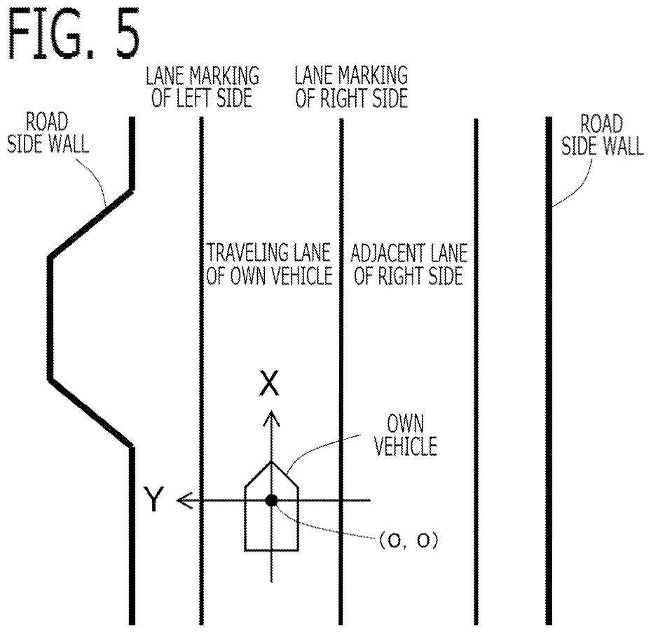

The side wall detection unit 11 calculates a position of the detection object in an own vehicle coordinate system. As shown in FIG. 5, the own vehicle coordinate system is a coordinate system which sets the traveling direction and the lateral direction of the own vehicle as two coordinate axes X and Y. The origin of the own vehicle coordinate system is set at a vicinity of a center of the own vehicle, such as a neutral steer point.

The side wall detection unit 11 extracts a road side wall from the detection objects detected by the millimeter wave radar. Unlike camera and LiDAR, the millimeter wave radar hardly be affected by weather and peripheral lightness, can detect the road side wall stably, and can maintain the correction performance of the position coordinate. For example, the side wall detection unit 11 extracts a detection object which exists in an area (area of road side) where a possibility that a side wall exists is high, as the road side wall. The side wall detection unit 11 extracts the road side wall from the detection objects, based on a strength of the reflected wave, a shape of the detection object, and the like. The road side wall is a wall which is provided in the road side and faces toward the road. Typical, it is a side wall provided dedicated for the road, but it may be a wall of a structure which does not belong to the road. The road side wall rises in the vertical direction, but it may incline to the vertical direction.

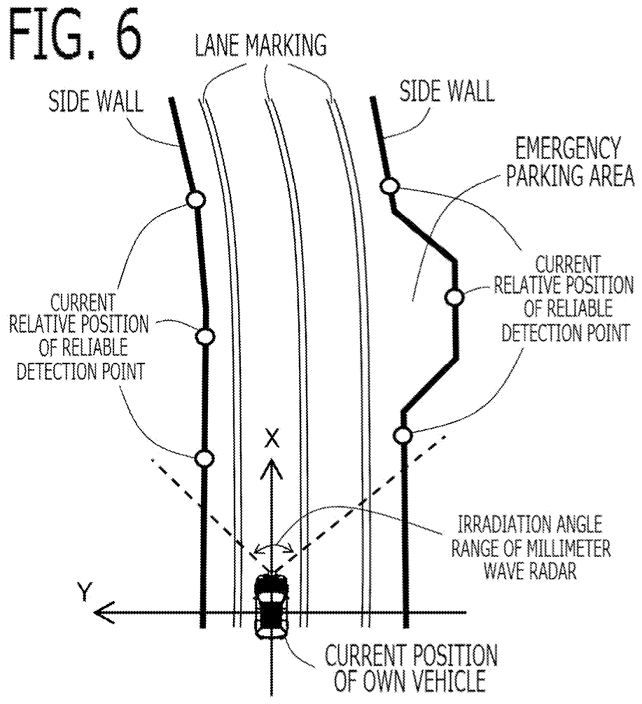

The side wall detection unit 11 removes a noise component from the detection signal of the millimeter wave radar, and extracts a reliable detection point of the road side wall. As shown in FIG. 6, the current reliable detection points of the road side wall become few. Accordingly, only by the detection points of the road side wall detected at a certain time point, shape of the side wall cannot be grasped with good accuracy. In the example of FIG. 6, characteristic shape of the road side wall of an emergency parking area cannot be grasped. Especially in the case of the millimeter wave radar, the reliable detection points which can be used for shape recognition become few.

The side wall detection unit 11 stores the positions in the own vehicle coordinate system of the detection points of the road side wall detected at each time point, to the storage apparatus 91, such as RAM.

### 1-2. Own Vehicle State Detection Unit 12

In the step S02 of FIG. 4, the own vehicle state detection unit 12 executes an own vehicle state detection processing (an own vehicle state detection step) that detects a position coordinate and traveling information of the own vehicle.

As the position detection apparatus 32, a GPS antenna which receives GPS signal outputted from satellites such as GNSS (Global Navigation Satellite System), and the like is provided. The own vehicle state detection unit 12 detects the position coordinate of the own vehicle, based on the GPS signal received by the GPS antenna. The position coordinate is a latitude, a longitude, an altitude, and the like. When the GPS signal cannot be detected, the own vehicle state detection unit 12 updates the position coordinate, based on the output signal of IMU (Inertial Measurement Unit). Instead of IMU, a vehicle speed, a steering angle, and the like which were acquired from the vehicle control apparatus 33 may be used.

As the position detection apparatus 32, a speed sensor, a yaw rate sensor, and the like are provided. The speed sensor is a sensor which detects a travelling speed (vehicle speed) of the own vehicle, and detects a rotational speed of the wheels, and the like. An acceleration sensor may be provided, and the travelling speed of vehicle may be calculated based on acceleration. The yaw rate sensor is a sensor which detects yaw rate information relevant to a yaw rate of the own vehicle. As the yaw rate information, a yaw rate, a yaw angle, a yaw moment, or the like is detected. If the yaw angle is time-differentiated, the yaw rate can be calculated. If prescribed calculation is performed using the yaw moment, the yaw rate can be calculated.

The own vehicle state detection unit 12 stores the traveling information (in this example, the vehicle speed and the yaw rate) of the own vehicle detected at each time point, to the storage apparatus 91, such as RAM.

### 1-3. Detected Side Wall Superposition Unit 13

In the step S03 of FIG. 4, the detected side wall superposition unit 13 executes a detected side wall superposition processing (a detected side wall superposition step) that converts the relative positions of the road side wall detected in the past, into relative positions of the road side wall on a basis of the current position of the own vehicle, based on the traveling information; and superimposes the current relative positions of the road side wall and the past relative positions of the road side wall after conversion at a plurality of time points and calculates relative positions of the road side wall after superposition.

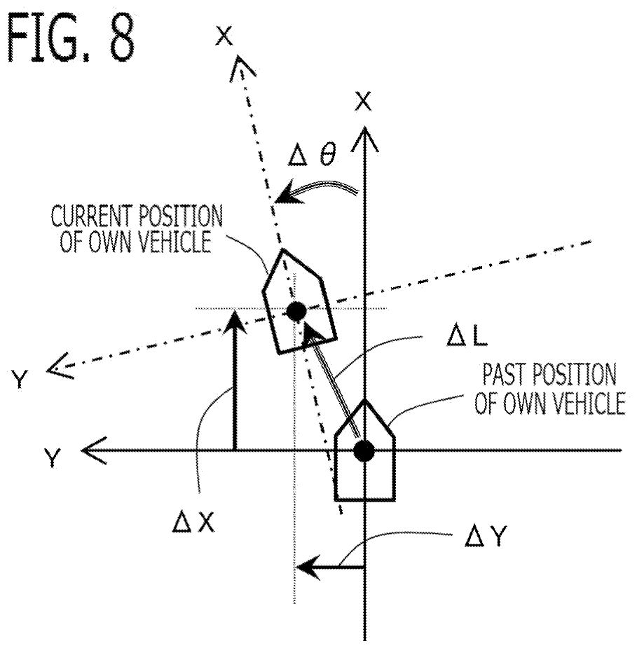

As shown in FIG. 8, the detected side wall superposition unit 13 calculates a traveling distance ΔL and a change amount of yaw angle Δθ of the current own vehicle on the basis of the position of the own vehicle (the own vehicle coordinate system) at the past detection time point of the relative position of the road side wall, based on the traveling information of the own vehicle.

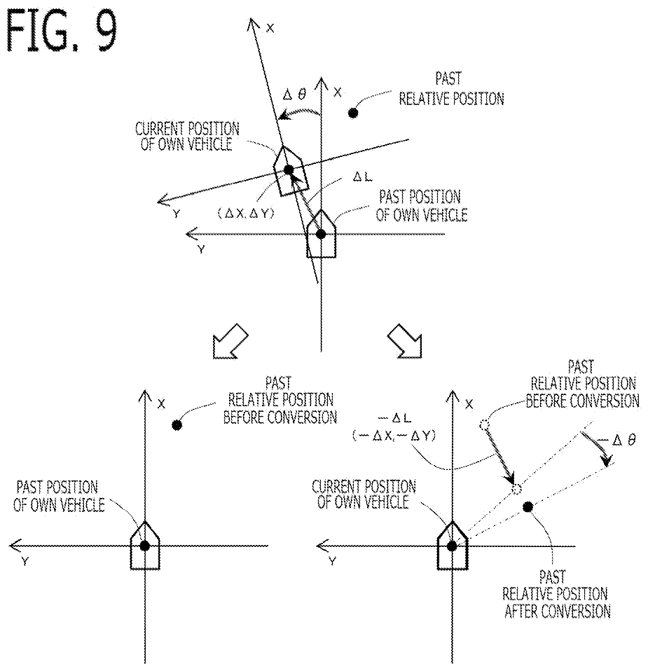

As shown in FIG. 9, when the own vehicle travels, the past relative position of the road side wall viewed on the basis of the current position of the own vehicle (the own vehicle coordinate system) moves to a direction opposite to the traveling direction of the own vehicle by the traveling distance ΔL of the own vehicle, and rotates to a direction opposite to the rotation direction of the own vehicle by the change amount of yaw angle Δθ.

The detected side wall superposition unit 13 calculates the traveling distance ΔL of the own vehicle and the change amount of yaw angle Δθ of the own vehicle from the past detection time point of the relative position of the road side wall to the current time point, based on the detection values of the vehicle speed and the yaw rate of the own vehicle. For example, the detected side wall superposition unit 13 calculates the change amount of yaw angle Δθ by integrating the yaw rate from the past time point to the current time point, and calculates the traveling distance ΔL by integrating the vehicle speed from the past time point to the current time point.

The detected side wall superposition unit 13 decomposes the traveling distance ΔL of the own vehicle into a traveling distance in the traveling direction ΔX and a traveling distance ΔY in the lateral direction, based on the change amount of yaw angle Δθ, using the next equation. If Δθ is small, approximate calculation can be performed.

$$Δ X = Δ L \times cos Δ θ ≅ Δ L \times ( 1 - \frac{1}{2} Δ {θ}^{2} ) Δ Y = Δ L \times sin Δ θ ≅ Δ L \times Δθ \qquad ( 1 )$$

The detected side wall superposition unit 13 converts the past relative position (Xwn, Ywn) of each detection point n of the road side wall, into the past relative position (Xwcnvn, Ywcnvn) of each detection point n of the road side wall on the basis of the current position of the own vehicle, based on the traveling distance (ΔX, ΔY) and the change amount of yaw angle Δθ of the own vehicle from the past detection time point of the relative position of the road side wall to the current time point.

As shown in the next equation, the detected side wall superposition unit 13 converts the past relative position (Xwn, Ywn) of each detection point n of the road side wall, into the past relative position (Xwcnvn, Ywcnvn) of each detection point n of the road side wall on the basis of the current position of the own vehicle, by performing an affine transformation which performs moving and rotation in an opposite direction to the traveling distance (ΔX, ΔY) and the change amount of yaw angle Δθ of the own vehicle from the past detection time point to the current time point.

$$[ \begin{matrix}Xwcnvn \\ Ywcnvn\end{matrix} ] = [ \begin{matrix}cos ( - Δ θ ) & - sin ( - Δ θ ) \\ sin ( - Δθ ) & cos ( - Δ θ )\end{matrix} ] [ \begin{matrix}Xwn - Δ X \\ Ywn - Δ Y\end{matrix} ] \qquad ( 2 )$$

About each of a plurality of the past detection time points of superposition object, the detected side wall superposition unit 13 calculates the traveling distance ΔL and the change amount of yaw angle Δθ of the own vehicle from the past detection time point to the current time point, and converts the past relative position of the road side wall into the past relative position of the road side wall on the basis of the current position of the own vehicle, based on the traveling distance ΔL and the change amount of yaw angle Δθ.

The plurality of past detection time points of superposition object are set to a plurality of detection time points which exists from the current time point to a superimposing period ago. The superimposing period is set so that the detection time points of superposition object do not increase too much. As the vehicle speed becomes fast, the superimposing period may be shortened.

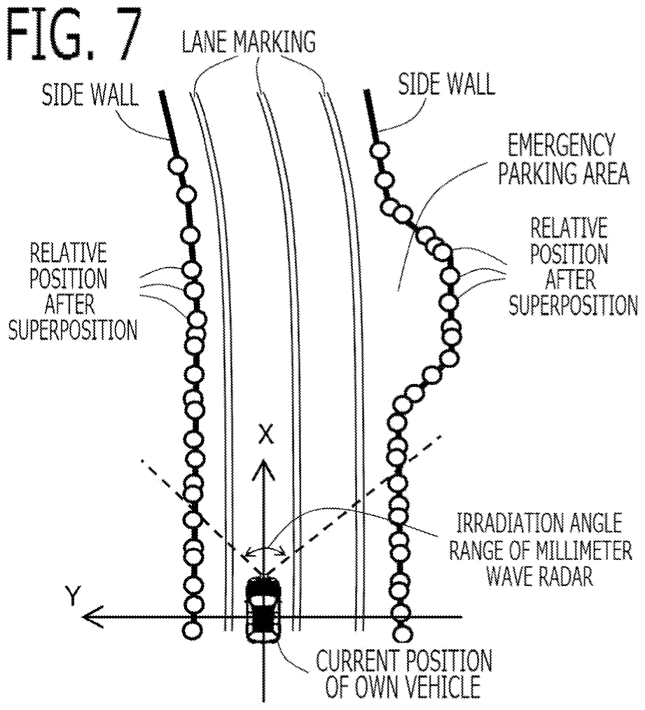

FIG. 7 shows the relative positions of the road side wall after superposition. Compared with the relative positions of the road side wall before superposition shown in FIG. 6, the number of detection points can be increased and the shape of the side wall can be grasped. In the example of FIG. 7, the shape of the road side wall of the emergency parking area can be grasped.

### 1-4. Map Side Wall Acquisition Unit 14

In the step S04 of FIG. 4, the map side wall acquisition unit 14 executes a map side wall acquisition processing (a map side wall acquisition step) that acquires the positions of the road side wall corresponding to the position coordinate of the own vehicle, from map data 5. The road information may be acquired from the map data 5 stored in the storage apparatus of the own position estimation apparatus 10 and the like inside the own vehicle. The road information may be acquired from the map data 5 stored in the server outside the own vehicle via the communication line. In this example, the map data 5 stored in the storage apparatus of the own position estimation apparatus 10 is used.

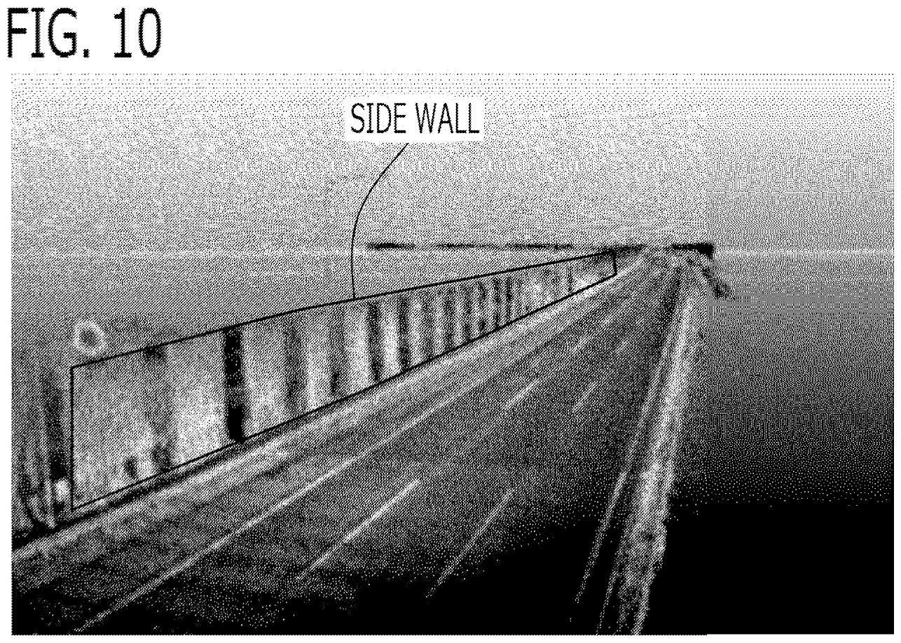

For example, as the map data 5, the high precision three-dimensional map data in which the three-dimension shape data of the road including the road side wall was stored is used. FIG. 10 show image figures of the high precision three-dimensional map data. As long as it is map data in which the position of the road side wall is stored, map data other than the high precision three-dimensional map data may be used.

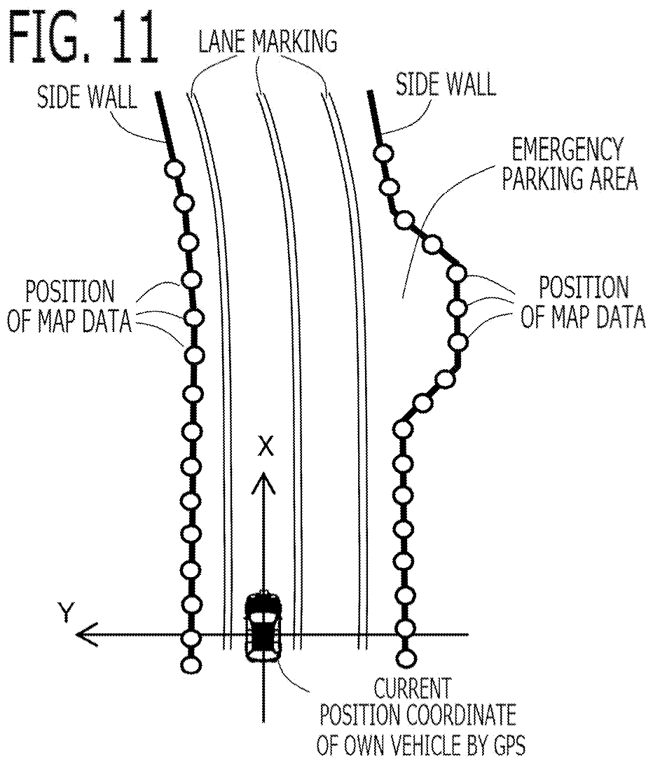

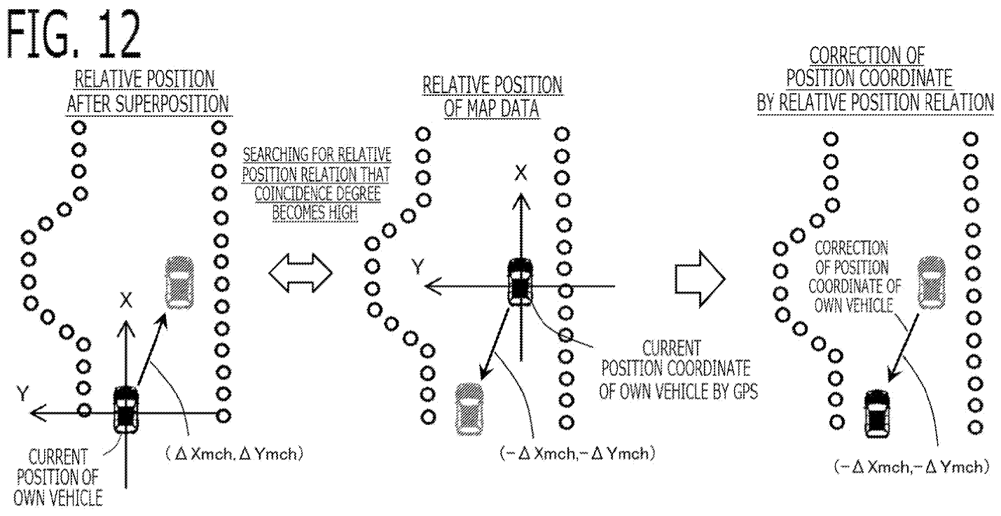

The map side wall acquisition unit 14 reads the data of the road side wall in the periphery of the position coordinate of the own vehicle from the map data 5, and acquires the positions of the road side wall. For example, a surface which extends along the lane and faces toward the lane in the road side is acquired as the road side wall. The acquired position of the road side wall is a horizontal two-dimensional position on the basis of latitude and longitude. For example, as shown in FIG. 11, the discrete positions of the roadside wall for every prescribed interval along the lane is acquired.

In the present embodiment, the map side wall acquisition unit 14 converts latitude and longitude of the road side wall of map data, into the relative position on the basis of the position of the own vehicle (position in the own vehicle coordinate system), based on the current position coordinate of the own vehicle detected by GPS signal, IMU signal, and the like, and the current traveling direction (traveling azimuth) of the own vehicle. The origin of this own vehicle coordinate system corresponds to the current position coordinate of the own vehicle detected by GPS signal, IMU signal, and the like.

The map side wall acquisition unit 14 may use the latitude and longitude of the road side wall of map data as it is.

### 1-5. Side Wall Coincidence Search Unit 15

In the step S05 of FIG. 4, the side wall coincidence search unit 15 executes a side wall coincidence search processing (a side wall coincidence search step) that searches for a relative position relation of the road side wall that a coincidence degree between the relative positions of the road side wall after superposition and the positions of the road side wall of the map data becomes high.

The side wall coincidence search unit 15 searches for the relative position relation where the coincidence degree between the relative position of each detection point of the road side wall after superposition and the relative position of each acquisition point of the road side wall of map data becomes the highest. The coincidence degree may not become strictly the highest, and the coincidence degree may be closer to the maximum value than a determination reference value. As the search, various kinds of well-known methods, such as ICP (Iterative Closest Point) algorithm and NDT (Normal Distributions Transform) scan matching, are used. Roughly, a moving amount and a rotation amount by which distances between both point groups become the shortest when making the relative positions of one point group move and rotate is searched. As the coincidence degree, a statistical evaluation value, such as a mean squared error of the distances (errors) between both point groups after moving and rotation, is calculated. As the relative position relation, a moving amount and a rotation amount of the position of the own vehicle coordinate system of one point group by which the coincidence degree between them becomes the highest are calculated.

If latitude and longitude are used as it is as the position of the road side wall of map data, after converting latitude and longitude of each acquisition point into a position in two-dimensional coordinate system of surface of the earth, the moving amount and the rotation amount of the two-dimensional coordinate system by which the coincidence degree between them becomes high are calculated.

### 1-6. Position Correction Unit 16

In the step S06 of FIG. 4, the position correction unit 16 executes a position correction processing (a position correction step) that corrects the position coordinate of the own vehicle, based on the relative position relation of the road side wall, and calculates a position coordinate after correction. The position correction unit 16 transmits the position coordinate after correction of the own vehicle to other processing apparatus, such as the vehicle control apparatus 33.

As shown in FIG. 12, the moving amount ΔXmch, ΔYmch of the own vehicle coordinate system when the relative positions of the road side wall after superposition are moved so as to coincide with the relative positions of the road side wall of map data corresponds to the correction amount to the current position coordinate of the own vehicle detected by GPS signal, IMU signal, and the like. The position correction unit 16 converts the moving amount ΔXmch, ΔYmch of the own vehicle coordinate system, into the correction amount of the position coordinate (latitude and longitude), based on the current traveling direction (traveling azimuth) of the own vehicle. Then, the position correction unit 16 calculates the position coordinate after correction of the own vehicle, by subtracting the correction amount of the position coordinate from the current position coordinate of the own vehicle detected by GPS signal, IMU signal, and the like.

According to this configuration, by comparing the relative positions of the road side wall after superposition obtained by superimposing the relative positions of the road side wall actually detected by the periphery monitoring apparatus 31, with the positions of the road side wall of map data, the position coordinate of the own vehicle can be corrected with good accuracy, based on the relative position relation between them.

If latitude and longitude are used as it is as the position of the road side wall of map data, when the relative positions of the road side wall after superposition are moved so as to coincide with the positions in the two-dimensional coordinate system corresponding to the latitude and longitude of the road side wall of map data, the position coordinate after correction of the own vehicle exists at the origin of the own vehicle coordinate system of the relative position of the road side wall after superposition after moving. Accordingly, the position correction unit 16 converts the moving amount of the relative positions of the road side wall after superposition for making it coincide with the positions of the road side wall of map data, into a position coordinate, and calculates the position coordinate after conversion as the position coordinate after correction of the own vehicle.

### 2. Embodiment 2

Next, the own position estimation apparatus 10 and the own position estimation method according to Embodiment 2 will be explained. The explanation for constituent parts the same as those in Embodiment 1 will be omitted. The basic configuration of the own position estimation apparatus 10 and the own position estimation method according to the present embodiment is the same as that of Embodiment 1. Embodiment 2 is different from Embodiment 1 in that a detection dead angle of the road side wall due to an obstacle is considered.

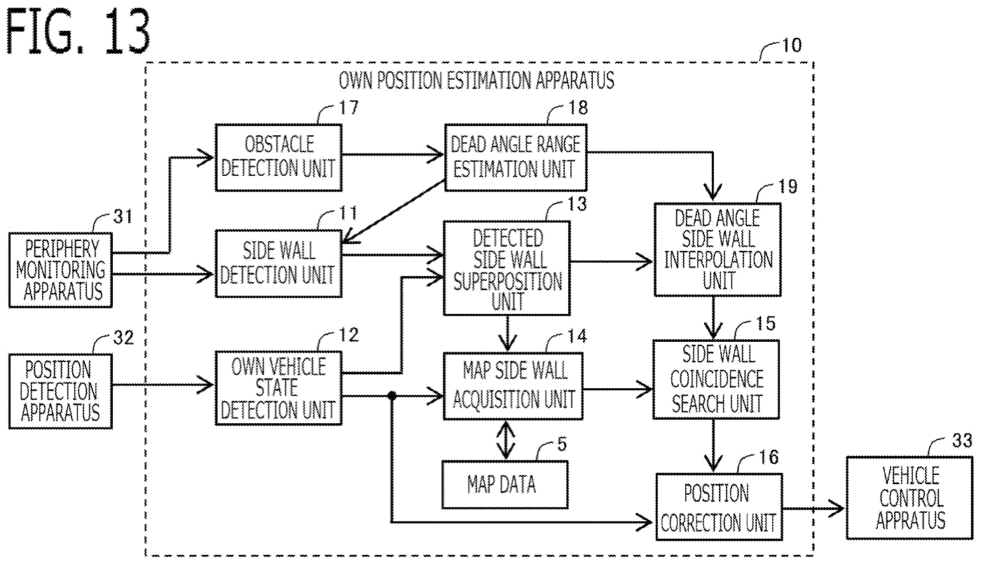

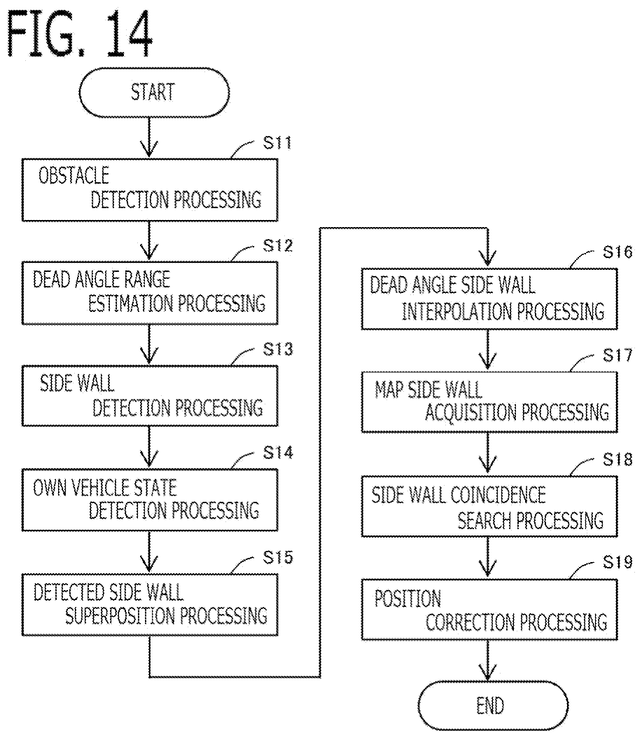

FIG. 13 shows the block diagram of the own position estimation apparatus 10 according to the present embodiment, and FIG. 14 shows the flowchart of the own position estimation apparatus 10 according to the present embodiment. The own position estimation apparatus 10 is further provided with an obstacle detection unit 17, a dead angle range estimation unit 18, and a dead angle side wall interpolation unit 19.

### <Obstacle Detection Unit 17>

In the step S11 of FIG. 14, the obstacle detection unit 17 executes an obstacle detection processing (an obstacle detection step) that detects a detection obstacle which obstructs detection of the road side wall by the periphery monitoring apparatus 31, based on the detection information of the periphery monitoring apparatus 31. The detection obstacles is other vehicle, a pedestrian, a roadside object, and the like. The obstacle detection unit 17 detects the detection obstacle which exists in the periphery of the own vehicle, based on the detection information, such as the front monitoring camera and the millimeter wave radar. For example, well-known image processing is performed to a picture of the front monitoring camera, a detection obstacle is detected, and a relative position of the detection obstacle on the basis of the position of the own vehicle is detected. A detection obstacle is detected based on a reflection intensity and a traveling speed of an object obtained from the detection information by the millimeter wave radar, and a relative position of the detection obstacle on the basis of the position of the own vehicle is detected. The obstacle detection unit 17 may detect other vehicle or a pedestrian as the detection obstacle, based on communication information from a portable terminal device possessed by the other vehicle or the pedestrian.

### <Dead Angle Range Estimation Unit 18>

In the step S12 of FIG. 14, the dead angle range estimation unit 18 executes a dead angle range estimation processing (a dead angle range estimation step) that estimates an angle range area which becomes a dead angle by the detection obstacle in detection of the road side wall by the periphery monitoring apparatus 31.

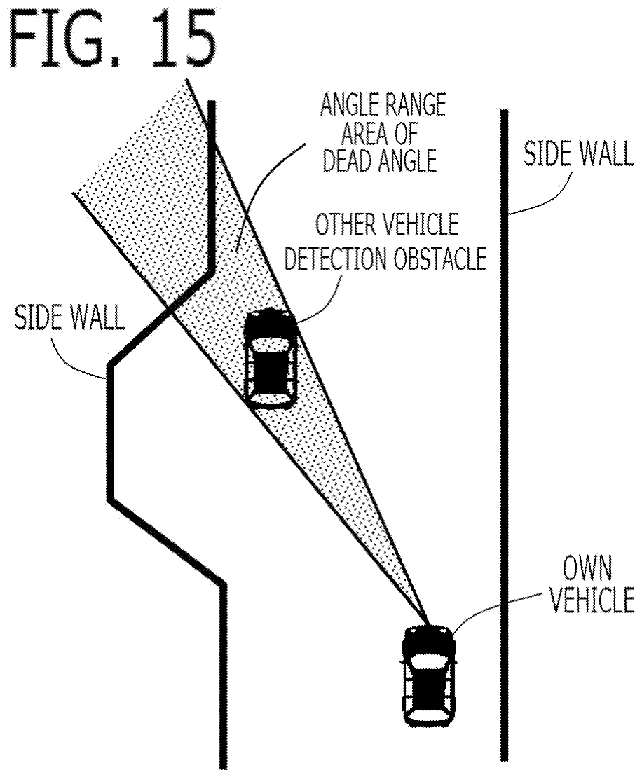

As shown in FIG. 15, an angle range where the detection obstacle exists among the detection angle range of the millimeter wave radar becomes a dead angle range. An area of this dead angle range is calculated in the own vehicle coordinate system. The dead angle range estimation unit 18 stores the relative positions of the angle range area of dead angle estimated at each time point, to the storage apparatus 91, such as RAM.

### <Side Wall Detection Unit 11>

In the step S13 of FIG. 14, similarly to Embodiment 1, the side wall detection unit 11 executes the side wall detection processing (the side wall detection step) that detects relative positions of the road side wall on the basis of the position of the own vehicle, based on detection information of the periphery monitoring apparatus 31 which monitors periphery of the own vehicle. At this time, the side wall detection unit 11 excludes the detection object detected by the millimeter wave radar in the dead angle range, from the road side wall, as not the road side wall.

### <Own Vehicle State Detection Unit 12>

In the step S14 of FIG. 14, similarly to Embodiment 1, the own vehicle state detection unit 12 executes the own vehicle state detection processing (the own vehicle state detection step) that detects the position coordinate and traveling information of the own vehicle.

### <Detected Side Wall Superposition Unit 13>

In the step S15 of FIG. 14, similarly to Embodiment 1, the detected side wall superposition unit 13 executes the detected side wall superposition processing (the detected side wall superposition step) that converts the relative positions of the road side wall detected in the past, into the relative positions of the road side wall on the basis of the current position of the own vehicle, based on the traveling information; and superimposes the current relative positions of the road side wall and the past relative positions of the road side wall after conversion at a plurality of time points and calculates the relative positions of the road side wall after superposition.

Similarly to the conversion of the relative position of the road side wall, the detected side wall superposition unit 13 may convert the relative positions of the angle range area of dead angle estimated in the past, into relative positions of the angle range area of dead angle on the basis of the current position of the own vehicle, based on the traveling information; and superimpose cumulatively the current relative positions of the angle range area of dead angle, and the past relative positions of the angle range area of dead angle after conversion at a plurality of time points, and calculate the relative positions of the angle range area of dead angle after superposition. This superimposing period may be set the same as the superimposing period for superimposing the relative positions of the road side wall. Even when the angle range area of dead angle is varied by traveling of the own vehicle, an angle range area of dead angle which affects the relative positions of the road side wall after superposition can be grasped.

### <Dead Angle Side Wall Interpolation Unit 19>

In the step S16 of FIG. 14, the dead angle side wall interpolation unit 19 executes a dead angle side wall interpolation processing (a dead angle side wall interpolation step) that estimates relative positions of the road side wall in the angle range area which becomes the dead angle, based on the relative positions of the road side wall after superposition before and after the angle range area which becomes the dead angle; and complements the relative positions of the road side wall after superposition with the estimated relative positions.

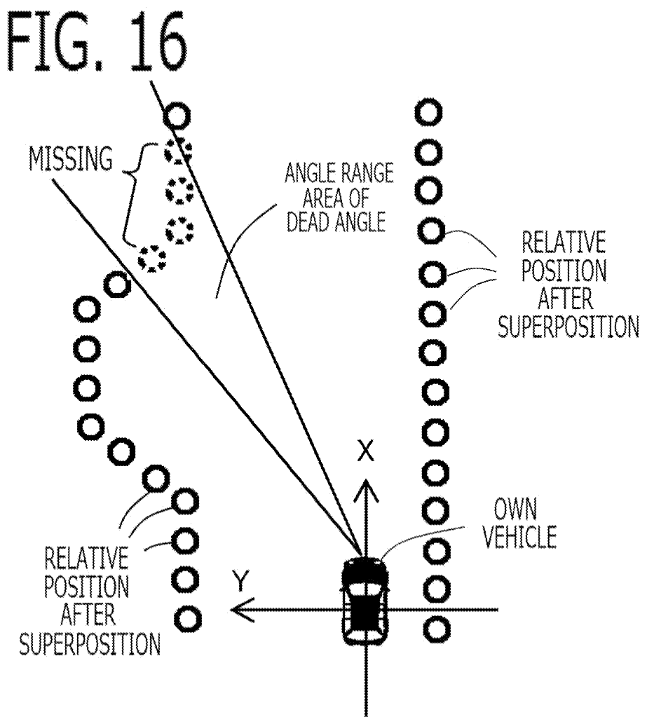

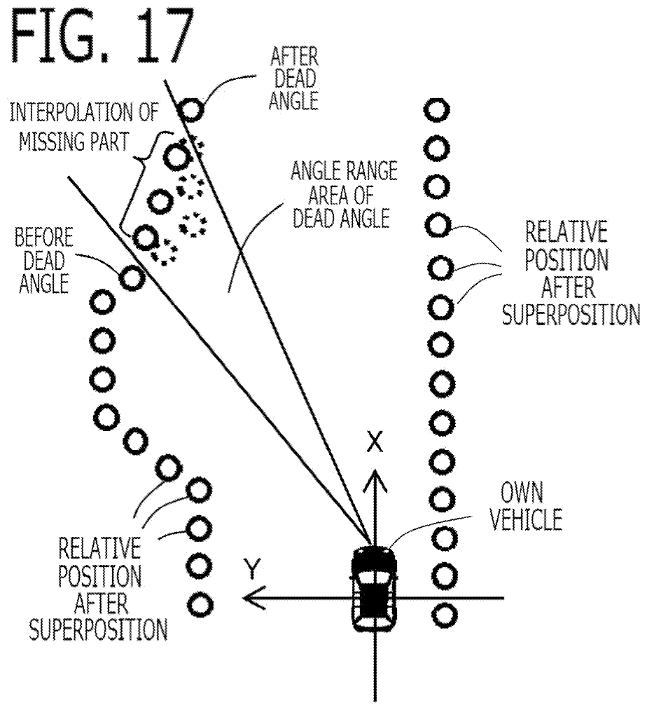

As shown in FIG. 16, the relative positions of the road side wall after the superposition corresponding to the angle range area of dead angle are missing. Then, as shown in FIG. 17, the relative positions of the road side wall in the angle range area of dead angle are estimated so as to connect between the relative positions of the road side wall after superposition before and after the angle range area of dead angle. For example, as shown in FIG. 17, it may be connected in a straight line shape.

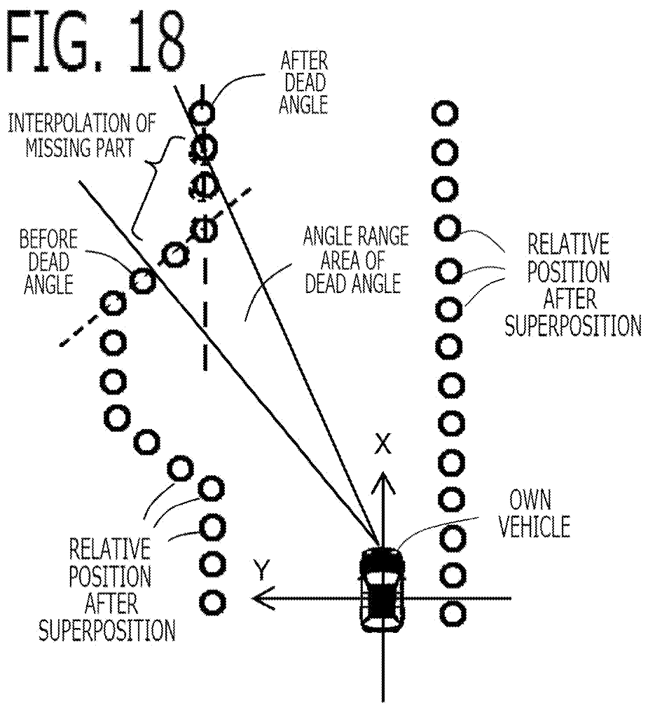

Alternatively, as shown in FIG. 18, the dead angle side wall interpolation unit 19 may estimate the relative positions of the road side wall in the angle range area which becomes the dead angle using lane shape. Specifically, when one (in this example, after) of the relative positions of the road side wall after superposition before and after the angle range area of dead angle is close to the lane, and the other (in this example, before) is far from the lane, the dead angle side wall interpolation unit 19 may extend the road side wall along the lane shape from one of the relative position of the road side wall which is close to the lane; extend the road side wall from the other of the relative position of the road side wall which is far from the lane, diagonally to the lane shape toward one of the relative position of the road side wall side; and estimate the relative positions of the road side wall in the angle range area of dead angle. As shown in FIG. 18, even though there is a road side wall which is not parallel to the lane, such as the emergency parking area, in the dead angle part, the dead angle part can be estimated with good accuracy.

The angle range area of dead angle after superposition may be used. The dead angle side wall interpolation unit 19 may determines a part where the relative positions of the road side wall after superposition is missing in the angle range area of dead angle after superposition; estimate the relative positions of the road side wall so as to connect between the relative positions of the road side wall after superposition before and after the missing part; and interpolate the missing part.

### <Map Side Wall Acquisition Unit 14>

In the step S17 of FIG. 14, similarly to Embodiment 1, the map side wall acquisition unit 14 executes the map side wall acquisition processing (the map side wall acquisition step) that acquires the positions of the road side wall corresponding to the position coordinate of the own vehicle, from map data 5.

### <Side Wall Coincidence Search Unit 15>

In the step S18 of FIG. 14, the side wall coincidence search unit 15 executes the side wall coincidence search processing (the side wall coincidence search step) that searches for the relative position relation of the road side wall that the coincidence degree between the relative positions of the road side wall after superposition interpolated by the dead angle side wall interpolation unit 19 and the positions of the road side wall of the map data becomes high. Since it is similar to Embodiment 1 except presence or absence of interpolation by the dead angle side wall interpolation unit 19, explanation is omitted.

### <Position Correction Unit 16>

In the step S19 of FIG. 14, similarly to Embodiment 1, the position correction unit 16 executes the position correction processing (the position correction step) that corrects the position coordinate of the own vehicle, based on the relative position relation of the road side wall, and calculates the position coordinate after correction.

### 3. Embodiment 3

Next, the own position estimation apparatus 10 and the own position estimation method according to Embodiment 3 will be explained. The explanation for constituent parts the same as those of Embodiment 1 or 2 will be omitted. The basic configuration of the own position estimation apparatus 10 and the own position estimation method according to the present embodiment is the same as that of Embodiment 1 or 2. Embodiment 3 is different from Embodiment 1 or 2 in that correction of the position coordinate of the own vehicle by the lane marking is performed.

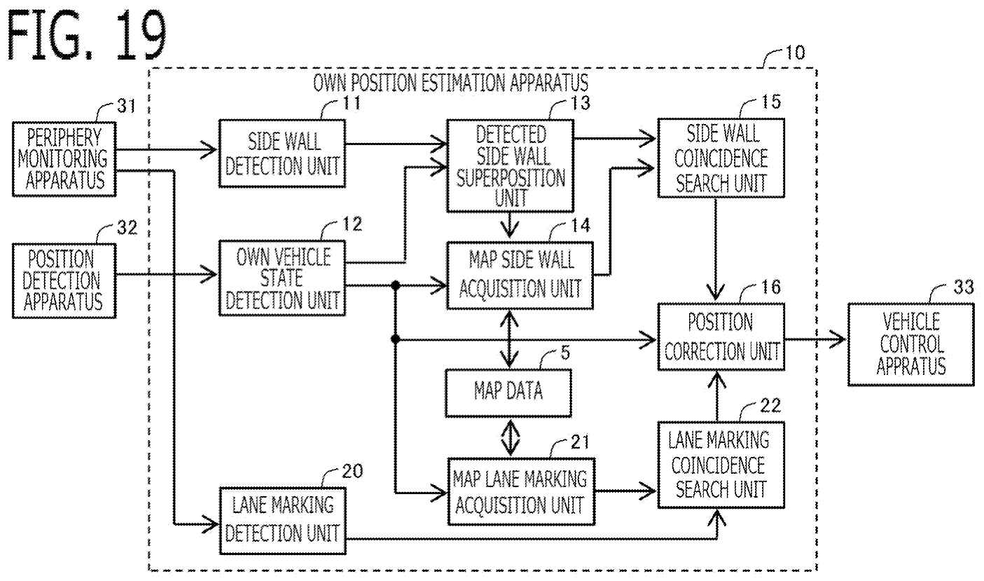

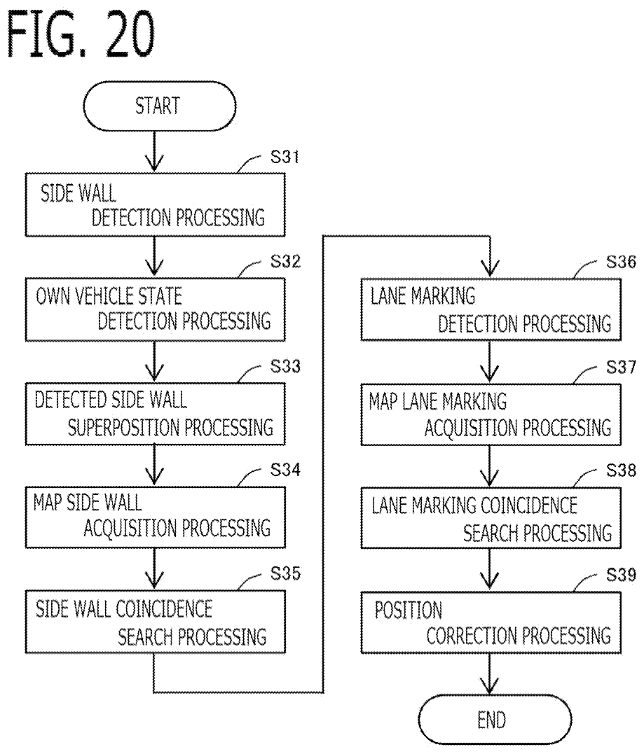

FIG. 19 shows the block diagram of the own position estimation apparatus 10 according to the present embodiment, and FIG. 20 shows the flowchart of the own position estimation apparatus 10 according to the present embodiment. The own position estimation apparatus 10 is further provided with a lane marking detection unit 20, a map lane marking acquisition unit 21, and a lane marking coincidence search unit 22. In the following, although a case where it is configured based on Embodiment 1 will be explained, it may be configured based on Embodiment 2. That is to say, similarly to Embodiment 2, the obstacle detection unit 17, the dead angle range estimation unit 18, and the dead angle side wall interpolation unit 19 may be provided.

### <Side Wall Detection Unit 11>

In the step S31 of FIG. 20, similarly to Embodiment 1, the side wall detection unit 11 executes the side wall detection processing (the side wall detection step) that detects relative positions of the road side wall on the basis of the position of the own vehicle, based on detection information of the periphery monitoring apparatus 31 which monitors periphery of the own vehicle.

### <Own Vehicle State Detection Unit 12>

In the step S32 of FIG. 20, similarly to Embodiment 1, the own vehicle state detection unit 12 executes the own vehicle state detection processing (the own vehicle state detection step) that detects the position coordinate and traveling information of the own vehicle.

### <Detected Side Wall Superposition Unit 13>

In the step S33 of FIG. 20, similarly to Embodiment 1, the detected side wall superposition unit 13 executes the detected side wall superposition processing (the detected side wall superposition step) that converts the relative positions of the road side wall detected in the past, into the relative positions of the road side wall on the basis of the current position of the own vehicle, based on the traveling information; and superimposes the current relative positions of the road side wall and the past relative positions of the road side wall after conversion at a plurality of time points and calculates the relative positions of the road side wall after superposition.

### <Map Side Wall Acquisition Unit 14>

In the step S34 of FIG. 20, similarly to Embodiment 1, the map side wall acquisition unit 14 executes the map side wall acquisition processing (the map side wall acquisition step) that acquires the positions of the road side wall corresponding to the position coordinate of the own vehicle, from map data 5.

### <Side Wall Coincidence Search Unit 15>

In the step S35 of FIG. 20, similarly to Embodiment 1, the side wall coincidence search unit 15 executes the side wall coincidence search processing (the side wall coincidence search step) that searches for the relative position relation of the road side wall that the coincidence degree between the relative positions of the road side wall after superposition and the positions of the road side wall of the map data becomes high. In the present embodiment, the side wall coincidence search unit 15 calculates at least a moving amount ΔXmch in the traveling direction of the own vehicle coordinate system, as the relative position relation of the road side wall.

### <Lane Marking Detection Unit 20>

In the step S36 of FIG. 20, the lane marking detection unit 20 executes a lane marking detection processing (a lane marking detection step) that detects relative positions of a lane marking of a road on the basis of the position of the own vehicle, based on the detection information of the periphery monitoring apparatus 31.

For example, the lane marking detection unit 20 performs well-known image processing to a picture of the front monitoring camera to detect the lane marking, and detects the relative positions of the lane marking on the basis of the position of the own vehicle. Although the lane marking is mainly a white line, it is not limited to the white line, and roadside objects, such as a road shoulder, may be recognized as the lane marking. The white line may be recognized from points that the reflection luminance of the laser radar is high. The relative positions of the lane marking are calculated in the own vehicle coordinate system.

### <Map Lane Marking Acquisition Unit 21>

In the step S37 of FIG. 20, the map lane marking acquisition unit 21 executes a map lane marking acquisition processing (a map lane marking acquisition step) that acquires positions of the lane marking corresponding to the position coordinate of the own vehicle from map data.

The map lane marking acquisition unit 21 acquires the positions of the lane marking in the periphery of the position coordinate of the own vehicle, from the map data 5. For example, the positions of the lane marking along the traveling lane of the own vehicle is acquired. The map side wall acquisition unit 14 converts latitude and longitude of the lane marking of map data, into the relative position on the basis of the position of the own vehicle (position in the own vehicle coordinate system), based on the current position coordinate of the own vehicle detected by GPS signal, IMU signal, and the like, and the current traveling direction (traveling azimuth) of the own vehicle.

### <Lane Marking Coincidence Search Unit 22>

In the step S38 of FIG. 20, the lane marking coincidence search unit 22 executes a lane marking coincidence search processing (a lane marking coincidence search step) that searches for a relative position relation of the lane marking that a coincidence degree between the detected relative positions of the lane marking and the positions of the lane marking of the map data becomes high.

The lane marking coincidence search unit 22 searches for the relative position relation where the coincidence degree between the detected relative positions of the lane marking and the relative positions of the lane marking of map data becomes the highest. For example, a moving amount ΔYmch in the lateral direction by which distances of both relative positions become the shortest when making the detected relative positions of the lane marking move in the lateral direction of the own vehicle coordinate system is searched. Only the relative position of the lane marking part located in the lateral direction of the own vehicle may be evaluated. For example, a square of the distance between them is calculated as the coincidence degree. As the relative position relation of lane marking, a moving amount ΔYmch in the lateral direction of the own vehicle coordinate system by which the coincidence degree between them becomes the highest is calculated. The searching method and the calculating method of relative position relation similar to the side wall coincidence search unit 15 explained in Embodiment 1 may be used.

### <Position Correction Unit 16>

In the step S39 of FIG. 20, the position correction unit 16 executes a position correction processing (a position correction step) that corrects the position coordinate in the traveling direction of the own vehicle, based on the relative position relation of the road side wall; corrects the position coordinate of the own vehicle in the lateral direction of the own vehicle, based on the relative position relation of the lane marking; and calculates the position coordinate after correction. The position correction unit 16 transmits the position coordinate after correction of the own vehicle to other processing apparatus, such as the vehicle control apparatus 33.

The position correction unit 16 totals the moving amount ΔXmch in the traveling direction of the own vehicle coordinate system as the relative position relation of the road side wall, and the moving amount ΔYmch in the lateral direction of the own vehicle coordinate system as the relative position relation of the lane marking; and calculates the moving amount ΔXmch, ΔYmch of the own vehicle coordinate system. The position correction unit 16 converts the moving amount ΔXmch, ΔYmch of the own vehicle coordinate system, into the correction amount of the position coordinate, based on the current traveling direction (traveling azimuth) of the own vehicle. Then, the position correction unit 16 calculates the position coordinate after correction of the own vehicle, by subtracting or adding the correction amount of the position coordinate from the current position coordinate of the own vehicle detected by GPS signal, IMU signal, and the like.

The detection accuracy of the position in the lateral direction of the lane marking part close to the own vehicle detected by the periphery monitoring apparatus 31, such as the camera, is high. By comparing the relative positions of the lane marking actually detected by the periphery monitoring apparatus 31, with the positions of the lane marking of map data, the position coordinate in the lateral direction of the own vehicle can be corrected with good accuracy, based on the relative position relation between them.

### 4. Embodiment 4

Next, the own position estimation apparatus 10 and the own position estimation method according to Embodiment 4 will be explained. The explanation for constituent parts the same as those of Embodiment 1, 2, or 3 will be omitted. The basic configuration of the own position estimation apparatus 10 and the own position estimation method according to the present embodiment is the same as that of Embodiment 1, 2, or 3. Processing of the side wall detection unit 11 and the map side wall acquisition unit 14 is different from Embodiment 1, 2, or 3.

Similarly to Embodiment 1 and the like, the side wall detection unit 11 detects relative positions of the road side wall on the basis of the position of the own vehicle, based on detection information of the periphery monitoring apparatus 31 which monitors periphery of the own vehicle.

In the present embodiment, the side wall detection unit 11 detects the relative positions of the road side wall in a specific area on the basis of the own vehicle which can secure detection accuracy of the road side wall by the millimeter wave radar, based on the detection information of the millimeter wave radar.

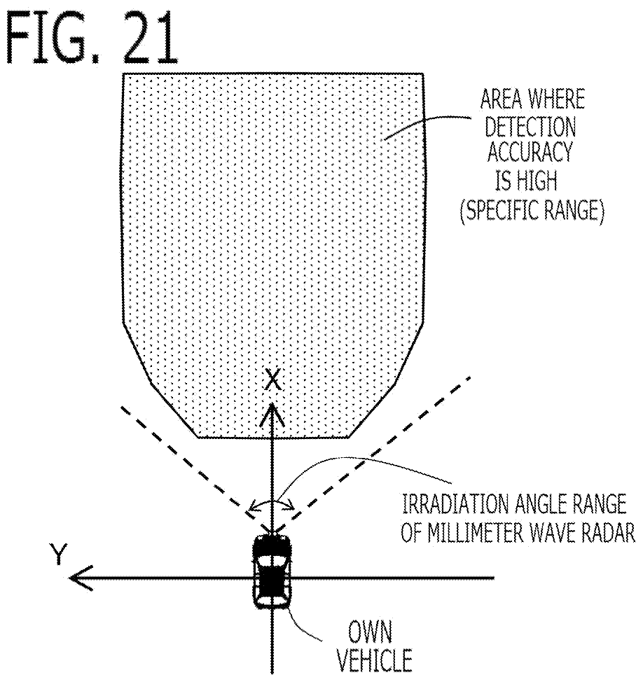

As shown in FIG. 21, the millimeter wave radar has a front area where the road side wall can be measured with high accuracy. This area where the detection accuracy is high differs according to type of the millimeter wave radar and the radar installed position. According to the above configuration, by setting the specific area in accordance with this area where the detection accuracy is high, the road side wall detected in the area where accuracy is low is excluded, the detection accuracy of the detected relative positions of the road side wall can be improved, and the correction accuracy of the position coordinate of the own vehicle can be improved.

For example, the specific area is preliminarily set as an area of specific relative positions in the own vehicle coordinate system. The side wall detection unit 11 excludes the relative positions outside the specific area, among the relative positions of the road side wall detected based on the detection information of the millimeter wave radar, and detects only the relative positions in the specific area as the final relative positions of the road side wall.

The map side wall acquisition unit 14 acquires the positions of the road side wall in an area corresponding to the specific area on the basis of the position coordinate of the own vehicle, from the map data 5.

According to this configuration, the positions of the road side wall of map data can be acquired corresponding to the specific area where the relative positions of the road side wall is detected by the millimeter wave radar; unnecessary positions of the road side wall of map data which do not become the comparison object are not acquired; and the calculation processing load of search in the side wall coincidence search unit 15 can be reduced.

The map side wall acquisition unit 14 converts the relative positions of the specific area which are set in the own vehicle coordinate system, into the position coordinates (latitude and longitude), based on the position coordinate of the own vehicle detected by GPS signal, IMU signal, and the like, and the traveling direction (traveling azimuth) of the own vehicle. Then, the map side wall acquisition unit 14 acquires the positions of the road side wall in the position coordinates of the specific area, from the map data 5.

Considering variation factors, such as an error of the position coordinate, an area obtained by expanding the specific area by a prescribed amount may be used for acquisition of the positions of the road side wall of map data.

The map side wall acquisition unit 14 may superimpose cumulatively the current specific area on the basis of the position coordinate of the own vehicle, and the past specific areas on the basis of the position coordinate of the own vehicle at a plurality of time points, and calculate a specific area after superposition; and acquire the positions of the road side wall in the specific area after superposition, from the map data 5. This superimposing period may be set the same as the superimposing period for superimposing the relative positions of the road side wall.

Specifically, the map side wall acquisition unit 14 may superimpose cumulatively the current position coordinates of the specific area after conversion, and the past position coordinates of the specific area after conversion at a plurality of time points, and calculate the position coordinates of the specific area after superposition; and acquire the positions of the road side wall in the position coordinates of the specific area after superposition, from the map data 5.

### 5. Embodiment 5

Next, the own position estimation apparatus 10 and the own position estimation method according to Embodiment 5 will be explained. The explanation for constituent parts the same as those of Embodiment 1, 2, 3, or 4 will be omitted. The basic configuration of the own position estimation apparatus 10 and the own position estimation method according to the present embodiment is the same as that of Embodiment 1, 2, 3 or 4. Processing of the position correction unit 16 is different from Embodiment 1, 2, 3, or 4.

Similarly to Embodiment 1 and the like, the position correction unit 16 corrects the position coordinate of the own vehicle, based on the relative position relation of the road side wall, and calculates the position coordinate after correction.

In the present embodiment, when the coincidence degree corresponding to the searched relative position relation of the road side wall is lower than a determination value, the position correction unit 16 does not correct the position coordinate of the own vehicle, based on the relative position relation of the road side wall. As explained in Embodiment 1, for example, as the coincidence degree of the road side wall, a statistical evaluation value, such as a mean squared error of the distances (errors) between both point groups of the side wall, is used.

According to this configuration, if correction is performed in the state where the shape of the road side wall detected by the millimeter wave radar and the shape of the road side wall of map data do not sufficiently coincide due to error factors, such as the detection error of the millimeter wave radar, or the inaccuracy of map data, the error of the position coordinate may conversely increase. By not correcting the position coordinate when the coincidence degree is low, it can suppress deterioration of the correction accuracy of the position coordinate.

If the position correction unit 16 is configured like Embodiment 3, when the coincidence degree corresponding to the searched relative position relation of the lane marking is lower than a determination value, the position correction unit 16 does not correct the position coordinate, based on the relative position relation of the lane marking.

As explained in Embodiment 3, for example, a square of the distance between them is calculated as the coincidence degree of the lane marking.

When the correction amount of the position coordinate of the own vehicle based on one or both of the relative position relation of the road side wall and the relative position relation of the lane marking is larger than a determination value of correction amount, the position correction unit 16 may not correct the position coordinate of the own vehicle, based on one or both of the relative position relation of the road side wall, and the relative position relation of the lane marking.

When the correction amount of the position coordinate exceeds an error range which is assumed for the position coordinate of the own vehicle, correction may be wrong. According to the above configuration, by not correcting the position coordinate when the correction amount of position error is larger than the determination value of correction amount, it can suppress deterioration of the correction accuracy of the position coordinate.

In each of the above-mentioned embodiments, there was explained the case where the millimeter wave radar is used as the periphery monitoring apparatus 31 which detects the relative positions of the road side wall. However, a laser radar (LiDAR) may be used as the periphery monitoring apparatus 31 which detects the relative positions of the road side wall. Especially, if the detection resolution of the laser radar is low and its detection points of the road side wall are few, the effect of improving the detection resolution of the road side wall is obtained by superposition.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. An own position estimation apparatus comprising at least one processor configured to implement:
a side wall detector that detects relative positions of a road side wall on a basis of a position of an own vehicle, based on detection information of a periphery monitoring apparatus which monitors periphery of the own vehicle;
an own vehicle state detector that detects a position coordinate and traveling information of the own vehicle;
a detected side wall superimposer that converts the relative positions of the road side wall detected in the past, into relative positions of the road side wall on a basis of the current position of the own vehicle, based on the traveling information, and superimposes the current relative positions of the road side wall and the past relative positions of the road side wall after conversion at a plurality of time points and calculates relative positions of the road side wall after superposition;
a map side wall acquisitor that acquires positions of the road side wall corresponding to the position coordinate, from map data;
a side wall coincidence searcher that searches for a relative position relation of the road side wall that a coincidence degree between the relative positions of the road side wall after superposition and the positions of the road side wall of the map data becomes high; and
a position corrector that corrects the position coordinate of the own vehicle, based on the relative position relation of the road side wall, and calculates a position coordinate after correction.

2. The own position estimation apparatus according to claim 1,
wherein the side wall detector detects the relative positions of the road side wall, based on detection information of a millimeter wave radar as the periphery monitoring apparatus.

3. The own position estimation apparatus according to claim 1,
wherein the side wall detector detects the relative positions of the road side wall in a specific range on a basis of the own vehicle which can secure detection accuracy of the road side wall by the periphery monitoring apparatus, based on the detection information of the periphery monitoring apparatus.

4. The own position estimation apparatus according to claim 1,
wherein the map side wall acquisitor acquires, from the map data, the positions of the road side wall in an area corresponding to a specific range on a basis of the position coordinate of the own vehicle which can secure detection accuracy of the road side wall by the periphery monitoring apparatus.

5. The own position estimation apparatus according to claim 4,
wherein the map side wall acquisitor superimposes cumulatively the current specific range on the basis of the position coordinate, and the past specific range on the basis of the position coordinate and calculates a specific range after superposition, and acquires the position of the road side wall in the specific range after superposition, from the map data.

6. The own position estimation apparatus according to claim 1, further comprising:
an obstacle detector that detects a detection obstacle which obstructs detection of the road side wall by the periphery monitoring apparatus, based on the detection information of the periphery monitoring apparatus;
a dead angle range estimator that estimates an angle range area which becomes a dead angle by the detection obstacle in detection of the road side wall by the periphery monitoring apparatus; and
a dead angle side wall interpolator that estimates relative positions of the road side wall in the angle range area which becomes the dead angle, based on the relative positions of the road side wall after superposition before and after the angle range area which becomes the dead angle, and complements the relative positions of the road side wall after superposition with the estimated relative positions.

7. The own position estimation apparatus according to claim 6,
wherein the dead angle side wall interpolator estimates the relative positions of the road side wall in the angle range area which becomes the dead angle, using lane shape.

8. The own position estimation apparatus according to claim 1,
wherein, when the coincidence degree corresponding to the searched relative position relation of the road side wall is lower than a determination value, the position corrector does not correct the position coordinate based on the relative position relation of the road side wall.

9. The own position estimation apparatus according to claim 1, further comprising:
a lane marking detector that detects relative positions of a lane marking of a road on the basis of the position of the own vehicle, based on the detection information of the periphery monitoring apparatus;
a map lane marking acquisitor that acquires positions of the lane marking corresponding to the position coordinate of the own vehicle, from map data; and
a lane marking coincidence searcher that searches fora relative position relation of the lane marking that a coincidence degree between the detected relative positions of the lane marking and the positions of the lane marking of the map data becomes high,
wherein the position corrector corrects the position coordinate in a traveling direction of the own vehicle, based on the relative position relation of the road side wall, corrects the position coordinate in a lateral direction of the own vehicle, based on the relative position relation of the lane marking, and calculates the position coordinate after correction.

10. The own position estimation apparatus according to claim 9,
wherein, when the coincidence degree corresponding to the searched relative position relation of the lane marking is lower than a determination value, the position corrector does not correct the position coordinate based on the relative position relation of the lane marking.

11. An own position estimation method comprising:
detecting relative positions of a road side wall on a basis of a position of an own vehicle, based on detection information of a periphery monitoring apparatus which monitors periphery of the own vehicle;
detecting a position coordinate and traveling information of the own vehicle;
converting the relative positions of the road side wall detected in the past, into relative positions of the road side wall on a basis of the current position of the own vehicle, based on the traveling information, and superimposing the current relative positions of the road side wall and the past relative positions of the road side wall after conversion at a plurality of time points and calculating relative positions of the road side wall after superposition;
acquiring positions of the road side wall corresponding to the position coordinate, from map data;
searching for a relative position relation of the road side wall that a coincidence degree between the relative positions of the road side wall after superposition and the positions of the road side wall of the map data becomes high; and
correcting the position coordinate of the own vehicle based on the relative position relation of the road side wall, and calculating a position coordinate after correction.
